(19) United States
(12) Patent Application Publication
(10) Pub. No.: US 2016/0176149 A1
(43) Pub. Date: Jun. 23, 2016

(54) VEHICLE FLOOR SYSTEM

(71) Applicant: Vixen Composites, LLC, Elkhart, IN (US)

(72) Inventors: Raymond M. Manderfeld, Granger, IN (US); Gordon Frost, Elkhart, IN (US)

(73) Assignee: Vixen Composites, LLC, Elkhart, IN (US)

(21) Appl. No.: 14/978,986

(22) Filed: Dec. 22, 2015

Related U.S. Application Data
(60) Provisional application No. 62/095,501, filed on Dec. 22, 2014.

(51) Int. Cl. B32B 3/12; B29C 70/52; B32B 7/12; B29C 65/00; B29C 35/02; B32B 3/08; B63B 5/24; B29C 65/48

(52) U.S. Cl. CPC B32B 3/12; B63B 5/24; B29C 70/521; B29C 65/48; B29C 66/721; B29C 66/45; B29C 35/0222; B32B 3/08; B32B 7/12; B29K 2063/00

(57) ABSTRACT

A vehicle floor system and method of manufacturing is provided having a lower layer, an upper layer, and a series of core sections interrupted by transverse structural members. The layers are impregnated with a heat-curable adhesive. The core sections and transverse structural members are compressed with the impregnated layers and cured to form a continuous sheet. The method of manufacturing the floor system where the upper layer is unwound and impregnated with the adhesive, the lower layer is unwound and impregnated with the adhesive. The core sections are placed between the layers and transverse members are placed between. A curing station is provided where the layers are compressed and adhesive heat-cured to create the continuous sheet. The continuous sheet is then separated by a saw.

### CROSS REFERENCE TO RELATED APPLICATIONS

This application claims the benefit of U.S. Provisional Application No. 62/095,501, filed Dec. 22, 2014, the disclosures of which are hereby incorporated by reference.

### BACKGROUND OF THE INVENTION

Vehicles, especially pontoon boats or recreational vehicles are frequently built on a flat surface. The flat surface is used to mount walls, seats, and the like, but is not a structural member. The flat surface merely sits on a frame. Further, insulation has to be added to keep heat from escaping. Honey-comb insulation is available but lacks sufficient structural properties to act as a supporting floor for a vehicle. Currently available flooring structures use a piece of laminated plywood as one layer to improve rigidity, but plywood has chemical and physical limitations. The methods for making these involve vacuum bags and other discrete processes that create individual discrete pieces, creating waste, gaps between the core and the structural members, and other defects that impact the structure or appearance. An improved flooring system and method for creating it is needed.

### SUMMARY OF THE INVENTION

The present disclosure describes an improved flooring structure where a reinforcing member provides additional rigidity along with a convenient place to mount other items. Reinforcing members are spaced according to the desired strength of the overall structure and possible mounting points. A core material provides strength to resist crushing of the structure and a smooth top and bottom surface are bonded to the core and reinforcing members using an epoxy or other adhesive. The core material can also provide insulating properties. The flooring structure is manufactured using a pultrusion process for creating a continuous sheet. The pultrusion process starts by unwinding upper and lower continuous rolls of material, such as filament mat or mesh. The material is then impregnated by drawing it through a bath of resin or other heat-curable epoxy. Core and reinforcing members are placed between the impregnated material and compressed and heated by a pultrusion die. The compression ensures contact between the layers, and the heat cures the epoxy resin. Located further down in the process is a pulling station where tank treads pull the materials through the die. Finally, the cured assembly is separated into individual sheets at a cutoff station.

### BRIEF DESCRIPTION OF THE DRAWINGS

A preferred embodiment of this invention has been chosen wherein:

FIG. 1 is an isometric view of the system as part of a pontoon boat;

FIG. 2 is an end view of the system in FIG. 1;

FIG. 3 is a partial view of the system in FIG. 2;

FIG. 4 is a section view of the system mounting;

FIG. 5 is an isometric view showing the internal detail of the system;

FIG. 6 is an isometric view of the method of manufacturing;

FIG. 7 is a side section view of the method as shown in FIG. 6; and

FIG. 8 is a partial section view 8 of the method shown in FIG. 7.

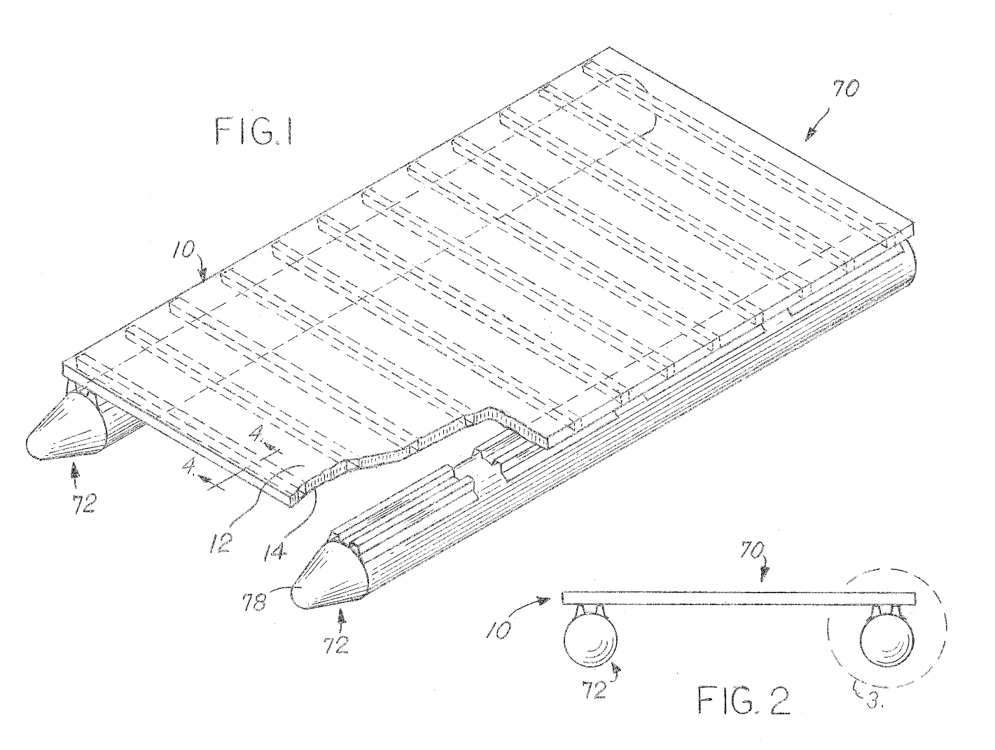

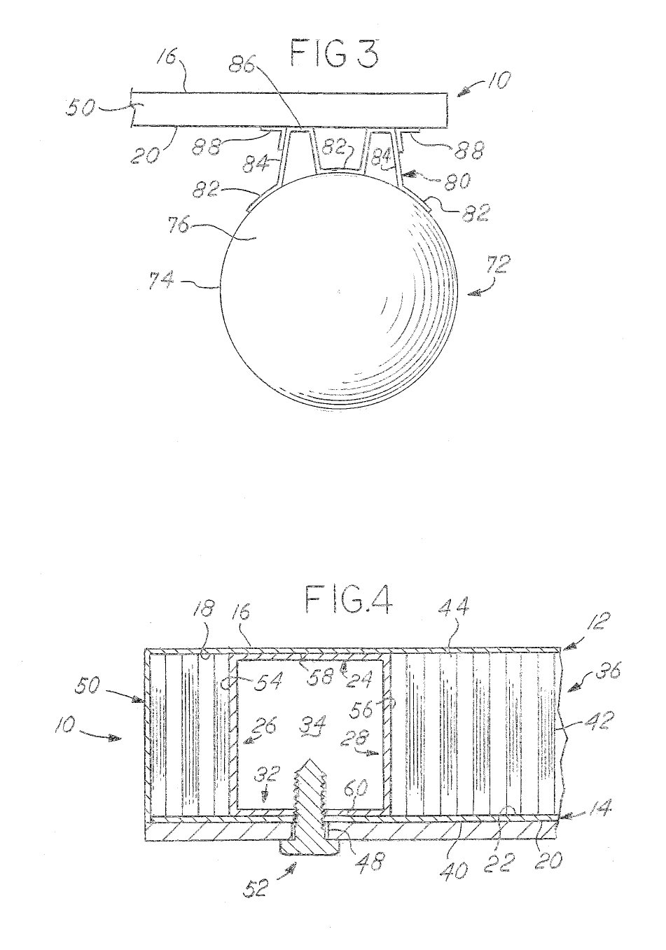

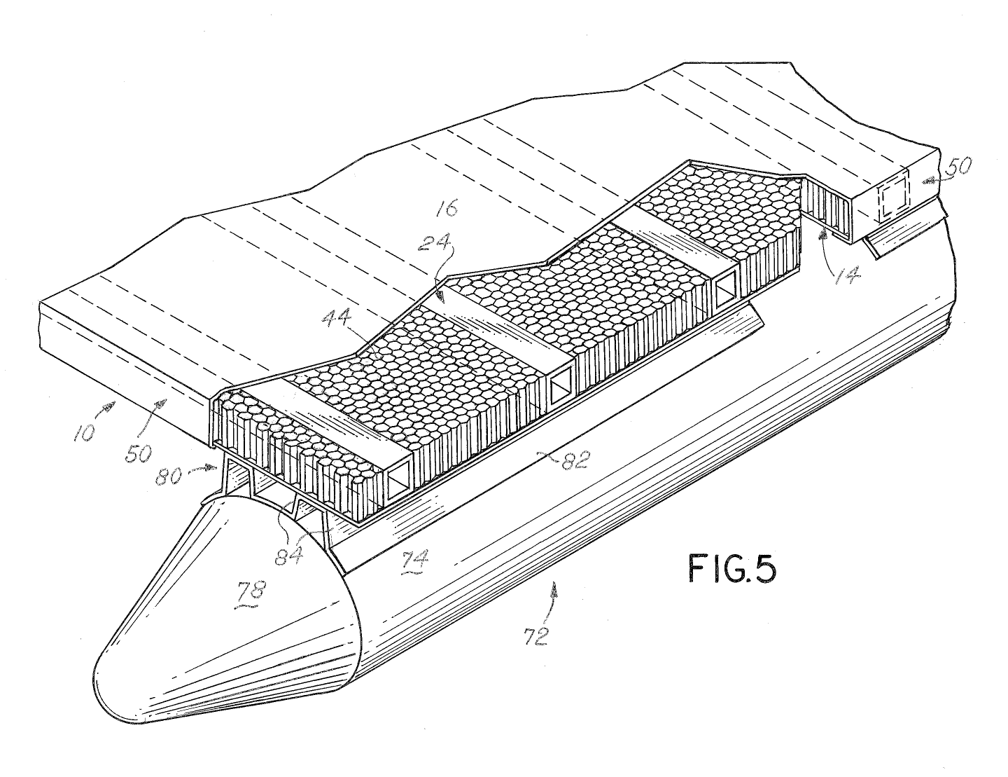

### DESCRIPTION OF THE PREFERRED EMBODIMENT

A flooring structure 10 for a pontoon boat 70 or other device has an upper wall 12 and a lower wall 14. The upper wall 12 and lower wall 14 are formed from a rigid sheet of fiberglass or equivalent. The upper and lower walls 12, 14 in the embodiment shown are fiberglass sheets that have been wetted with epoxy resin. Both upper and lower walls 12, 14 resist stretching or compressing and are an integral part of the strength of the structure 10. The upper wall 12 has an exposed surface 16 and an internal surface 18. The lower wall 14 has an equivalent exposed surface 20 and an internal surface 22. The flooring structure 10 is attached to individual pontoons 72 to form both a flooring surface and flooring structure. The specification is directed towards a floor in a pontoon boat 70, but it is contemplated that the structure 10 is used for walls, roofing, or other purposes where a rigid flat sheet is needed.

Located between the upper wall 12 and lower wall 14 are two different structural parts. An elongate member 24 is a hollow tube with side walls 26, 28 and a top 30 and bottom wall 32. The elongate member 24 has terminal ends. The elongate member 24 as shown is a square tube, made from fiberglass, and can be hollow. A hollow passage 34 can be used to route wires, hoses, or other things. The elongate member 24 can be “I” or “T” shaped to provide the structural rigidity. The top 30 and bottom wall 32 can be used to attach external items, such as walls, seats or similar devices as these walls are better for holding fasteners. The side walls 26, 28 have outside surfaces 54, 56 and the top and bottom walls 30, 32 have outside surfaces 58, 60 respectively. It is contemplated that the elongate member 24 is made from steel, aluminum, wood, or a resin impregnated fiberglass material in a separate pultruded process.

Located adjacent to the elongate member 24 is a core structure 36. The core structure 36 as shown is a honeycomb shape but other materials or structures are contemplated. It has a top surface 38 and a bottom surface 40. Located between the top surface 38 and the bottom surface 40 is a series of transverse walls 42. The transverse walls 42 intersect adjacent transverse walls 42 to form cavities 44. The cavities 44 are shown empty but can be filled with foam or other filler to modify the strength or insulation properties. The cavities 44 as shown are six-sided, but other shapes are possible. The top surface 38 is formed by a terminal edge of a series of transverse walls 42. The transverse walls 42 travel continuously from the top surface 38 to the bottom surface 40 uninterrupted. The transverse walls 42 are adapted to attach to both internal surfaces 18, 22. The cavities 44 form sealed pockets once the top surface 38 and bottom surface 40 are bonded to the internal surfaces 18, 22. The transverse walls 42 are sealed and bonded to the top and bottom walls 30, 32 and provide strength to keep the top surface 38 and bottom surface 40 separated. The core structure 36 has transverse edges and lateral edges. As shown, the lateral edges are aligned with the terminal ends of the elongate member 24. The transverse edges of the core structure 36 are in contact with the side walls 26, 28 of the elongate member 24.

The core structure 36 is interrupted by the elongate member 24 as shown in FIG. 4. As assembled into a completed structure 10, the upper wall 12 and lower wall 14 completely overlay the core structure 36 and elongate member 24. Specifically, internal surface 18 is bonded to the top surface 38 where the upper wall 12 overlays the core structure 36. Where the upper wall 12 overlays the elongate member 24, the internal surface 18 is bonded to the outside surface 58. Correspondingly, the internal surface 22 is bonded to the bottom surface 40 where the lower wall 14 overlays the honeycomb core structure 36. Where the lower wall 14 overlays the elongate member 24, the internal surface 22 is bonded to the outside surface 60. The bonding is necessary to prevent relative movement between the adjacent surfaces. Bonding can be accomplished through mechanical means, such as fasteners or adhesive strips, glue, or other means. The bonding is especially critical where the structure 36 meets the elongate member 24. The honeycomb structure is formed of a continuous series of intersecting walls to form a monolithic piece. It is contemplated that an adhesive strip 127 is located between the core structure 36 and elongate member 24 to ensure they remain in contact during the manufacturing process.

Lateral sides of the flooring structure 10 are bordered with a transverse sidewall 50 of the same material as the upper wall 12 and lower wall 14 that covers and protects the core structure 36 or elongate member 24.

The flooring structure 10 gains its strength from all of the components. As installed as part of another assembly, weight would be placed on the upper wall 12. If the weight is placed between two supports that are underneath the lower wall 14, the upper wall 12 would be in compression and the lower wall 14 would be in tension. The core structure 36 provides several functions. First, it provides support under the upper wall 12 to prevent it from moving closer to the lower wall 14. Second, the bonding between the structure 36 and the upper wall 12 and lower wall 14 prevents any relative movement between the two surfaces. The elongate member 24 provides a rigid mounting point for external items to be affixed, along with the rigidity of the member itself.

The pontoons 72 have an outside diameter 74 and end caps 76, 78 to form a buoyant member. Mounted to each pontoon 72 are M brackets 80. The M brackets 80 have a mounting portion 82 that mounts to the outside diameter 74. The M brackets 80 have upstanding walls 84 that protrude upward from the mounting portion 82 and terminate in a top wall 86. Adjacent to the top wall 86 are mounting brackets 88 that are either integral to the M brackets 80 or mounted to them. The mounting brackets 88 allow a threaded fastener 52 to be driven through a hole 48 into the bottom wall 32.

The elongate member 24 is located inside the flooring structure 10 to align with mounting points on a vehicle. Should the flooring structure 10 be incorporated into a pontoon boat 70, the “M” brackets on the top of each pontoon could be affixed to the elongate member 24. The elongate member 24 could be located inside the flooring structure 10 perpendicularly to the pontoons to mechanically tie one pontoon to another. On the opposite side, engine mounts, awnings, seats, or other objects could be also mounted to the elongate member 24. The elongate member 24 may be formed through a pultrusion process.

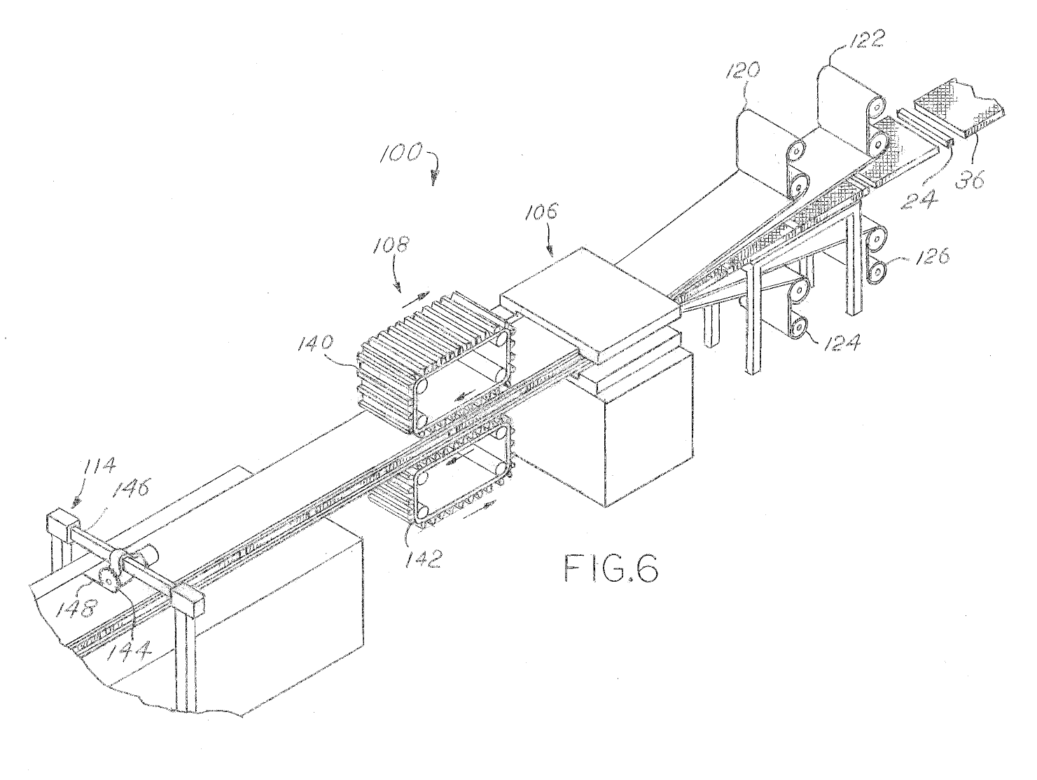

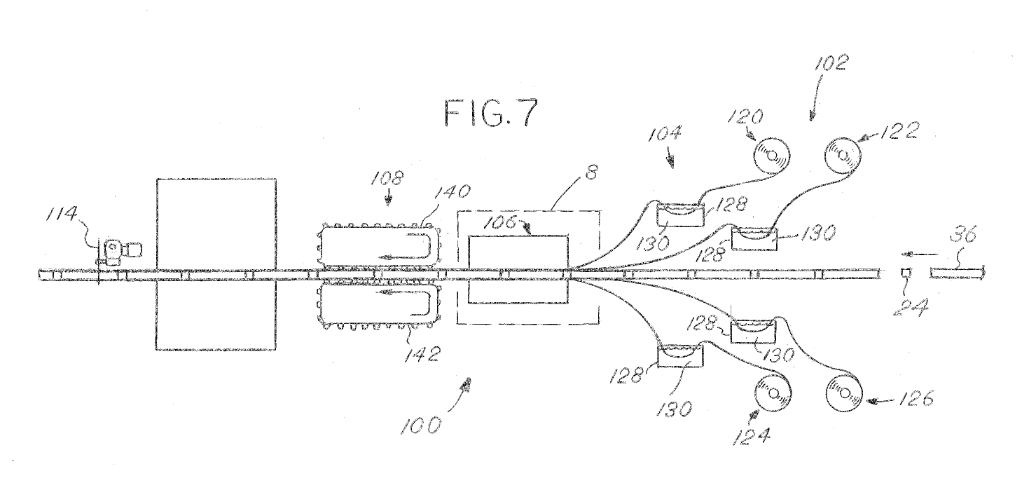

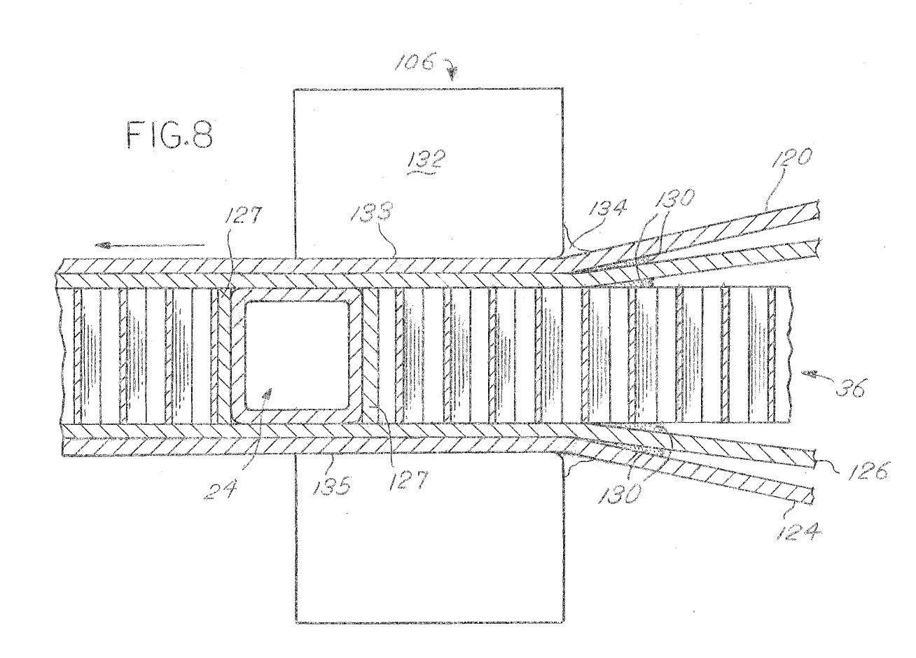

The flooring structure 10 is manufactured using a pultrusion process 100 shown in FIGS. 6-8 and described below. Generally, pultrusion is known in the art, but for clarity purposes, the process 100 creates a laminated and bonded continuous sheet or length of material, formed by adding and adhering layers that are then pulled through the process 100 instead of pushed. The novel process 100 described herein is divided up into several main sections. The unwinding and layering section 102 is where the source materials are combined. Next, a resin impregnation station 104 adds resin 130 to the layered materials. A curing station 106 compresses and cures the resin to make a continuous sheet 112. After the curing station 106, a pulling station 108 moves the cured material. Post-processing of the sheet can occur in a paint booth or other station 110. Lastly, a cutoff station 114 separates the continuous sheet 112 into individual panels 116.

The unwinding and layering section 102 has several rolls of various types, depending on the finished material desired. A top roll 120 and a second roll 122 are unwound. As shown, the process 100 has two top layers with the top roll 120 being filament or fiberglass mat and the second roll 122 is mesh. Each layer has its own purpose, such as surface finish, tensile strength, or edge finishing. It is contemplated that the process 100 includes other layers in addition to or exchange for the top and second rolls. A bottom roll 124 and a third roll 126 use the same materials in the same order as the top roll 120 and the second roll 122, but it is contemplated that they use different materials in a different configuration. It is also contemplated that there is only a top roll 120 and a bottom roll 124.

Located between the upper rolls 120, 122 and lower rolls 124, 126 is a series of core structure 36 with reinforcement elongate members 24. Where the core structures 36 abut reinforcement elongate members 24, adhesive 127 can be present, either in a sheet or liquid form to firmly secure the two. The adhesive 127 prevents gaps and other voids where the core structure 36 meets the elongate member 24. Gaps between them create stress risers in the material, so keeping the two firmly secured as they proceed through the process 100 is important.

Next, the unwound layers from rolls 120, 122, 124, 126 pass through the impregnating station 104 where each of the layers pass through individual baths 128 where resin 130 permeates the layer. Frequently, a roller (not shown) holds down the layer as it passes through the bath 128. The individual layer exits as a coated and saturated layer, where it proceeds to the curing station 106 where it first gets formed by a sizing die 132. The sizing die 132 has an upper surface 133 and a lower surface 135. The two surfaces are spaced apart to define a gap where the materials will be pulled through. As the materials are pulled through, the sizing die 132 compresses them to ensure full contact of the resin impregnated materials to the core structure 36. The amount of compression is related to the surface finish of the upper exposed surface 16 and lower exposed surface 20.

At the curing station 106, excess resin 134 builds up at the entrance of the sizing die 132 as material is pulled through. This is shown in FIG. 8. The core structure 36, elongate members 24, and the coated layers all are compressed and heated, causing the resin 130 to cure. The combined materials and cured resin exit the curing station 106, where they move to the pulling station 108. It is contemplated that instead of resin 130, a layer of adhesive or thermoplastic is applied between layers and is reflowed inside the curing station 106 to bond the layers. It is further contemplated that one or several of the layers are coated with a thermoplastic to reflow. The curing station 106 has zones where heating and cooling can be applied while the materials pass through. It is contemplated that cooling is done elsewhere in the process.

Pull rolls 140, 142 are located after the curing station 106 in the pulling station 108. The pull rolls 140, 142 are shown as a tank tread but can be any other type of device that can pull the layers through the curing station 106, impregnation station 104, and unwinding station 102. The pull rolls 140, 142 determine the speed the materials move through the process. A cutoff station 114 is where the continuous sheet is separated into individual sheets. Located between the cutoff station 114 and the pull rolls 140, 142 is an optional post-processing station. This station could contain a paint booth, surface finishing, coating, edge trim, or other necessary processes to create the finished panel.

A saw 144 slides across the sheet on a frame 146. Because the sheet is continuously moving, the frame 146 may be required to move along the sheet at the same speed the sheet is moving as it cuts to keep the cut 148 straight.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A method for continuously manufacturing a construction panel, said method comprising:
providing a pultrusion die having an upper surface being spaced apart from a lower surface by a die spacing distance;
providing a plurality of core structures for forming an interior of said panel, each of said core structures having lateral edges, transverse edges, and opposite sides being spaced apart by a core thickness;
providing an elongate structural member having lateral edges and terminal ends;
providing a first fiber reinforcement material for being placed on one said sides of said core structure and a second fiber reinforcement material for being placed on another of said sides of said core structure;
compressing said first and second fiber reinforcement material to measure a compressed thickness;
setting said die spacing distance to the core thickness plus said compressed thickness of said first and second fiber reinforcement materials;
wetting said first and second fiber reinforcement materials with epoxy resin;
feeding said wetted first and second fiber reinforcement materials on opposite sides of a first one of said core structures into said pultrusion die between said upper and lower surfaces;
placing said elongate structural member in adjacent contact to said first core structure;
placing a second one of said core structures adjacent to said elongate structural member opposite said first core structure;
pulling said first and second core structures through said pultrusion die with said elongate structural member therebetween; and
curing said panels passing through said pultrusion die so that said core structures are in contact with said elongate structural member after said curing.

2. The method of claim 1, bonding said elongate structural member to a transverse edge of said core structure.

3. The method of claim 2, providing a pressure-sensitive adhesive to bond said elongate structural member to said transverse edge of said core structure.

4. The method of claim 1, providing cooling portions in said pultrusion die.

5. A reinforced framing system for use with a vehicle, said framing system comprising:
an upper wall having an exposed surface and an internal surface;
a lower wall having an exposed surface and an internal surface, said upper wall separated from and substantially parallel to said lower wall;
a core structure separating said upper wall from said lower wall, said structure affixed to and in continuous contact with said upper and lower wall;
an elongate member located between and in contact with said upper and said lower wall, said elongate member being made of a substantially rigid material;
said core structure located adjacent to and in continuous contact with said elongate member; and
said upper wall and said lower wall affixed to said core structure and said elongate member.

6. The reinforced framing system of claim 5, said core structure being bonded to said elongate member.

7. The reinforced framing system of claim 6, said core structure having honeycomb chambers being substantially perpendicular to said upper and lower walls.

8. The reinforced framing system of claim 5, said upper and lower wall being affixed to said core structure and said elongate member with adhesive.

9. The reinforced framing system of claim 5, and a transverse wall intersecting said upper wall and said lower wall to form a perimeter wall of said framing system.

10. A method of making a continuous construction panel, said method comprising:
unwinding an upper layer of material, unwinding a lower layer of material, providing an impregnating material to saturate said upper and lower layers with a heat-curable adhesive;
locating core structure between said upper layer and said lower layer, providing an elongate member in a transverse orientation interrupting adjacent core structures;
providing a pultrusion die compressing said upper layer, said core structure, said transverse elongate members, and said lower layer portions heating a portion of said pultrusion die to cure said heat-curable adhesive and create a continuous layer;
pulling said continuous layer through said pultrusion die; and
cutting said continuous layer to create individual sheets.

11. The method of claim 10, and providing adhesive between said core structures and said transverse elongate members.

12. The method of claim 11, and applying a biasing force to compress said core structures to said transverse elongate members.

13. The method of claim 10, and providing a second layer located between said upper layer and said core structures.

14. The method of claim 13, and providing a third layer located between said lower layer and said core structures.
